(19) United States
(12) Patent Application Publication
(10) Pub. No.: US 2023/0103097 A1
(43) Pub. Date: Mar. 30, 2023

(54) METHOD OF PROVIDING A TABLE GAME AND AN ASSOCIATED SYSTEM

(71) Applicant: Paltronics Australasia Pty Limited, Taren Point (AU)

(72) Inventors: Dean Wright, Taren Point (AU); Angelo Palmisano, Henderson, NV (US)

(21) Appl. No.: 17/952,023

(22) Filed: Sep. 23, 2022

(30) Foreign Application Priority Data
Sep. 30, 2021 (AU) 2021240238

(51) Int. Cl. G07F 17/32

(52) U.S. Cl. CPC G07F 17/323; G07F 17/3223; G07F 17/3241; G07F 17/3293

(57) ABSTRACT

The embodiment provides a method of providing a table game at a table 3 to at least one player 5 having a mobile digital device 21. This method allows the player 5 to avoid touching traditional gaming elements, such as chips, cards, etc. The player's mobile digital device 21 is configured to communicate with a gaming server 2 so as to allow the player 5 to participate in the table game.

### CROSS-REFERENCE TO RELATED APPLICATION

This patent application claims priority to Australian Patent Application No. 2021240238 filed Sep. 30, 2021, which application is herein incorporated by reference in its entirety.

### TECHNICAL FIELD

The present invention relates to methods and associated systems for providing table games. Embodiments of the present invention find application, though not exclusively, in gaming establishments such as casinos.

### BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The COVID pandemic has heightened general awareness of the importance of hygiene and the potential for infection through contact with physical surfaces. It has been appreciated by the inventors that traditional table games typically require various gaming elements to be handled by multiple people. For example, a card game will typically require the players and the dealer to swap cards and chips, which poses an infection risk.

Another aspect that has been appreciated by the inventors is that table games may be susceptible to malfeasance such as collusion between the dealer and a player. It has been appreciated that table games can also present security and tracking issues associated with the handling of table game elements such as chips and cards.

### SUMMARY OF THE INVENTION

It is an object of the present invention to overcome, or substantially ameliorate, one or more of the disadvantages of the prior art, or to provide a useful alternative.

According to a first aspect of the invention there is provided a method of providing a table game at a table to at least one player having a mobile digital device, the method including: providing a gaming server; a configurator being disposed at or adjacent to the table, the configurator being operable to configure the least one player's mobile digital device to form a communications connection with the gaming server; allowing the at least one player to make an input into their mobile digital device, the input defining a play parameter for an upcoming table game; communicating the play parameter to the gaming server; running the table game in accordance with pre-defined table game rules; operating game surveillance equipment so as to generate table game play data; communicating said table game play data to the gaming server; at a conclusion of a table game, using the gaming server to process said pre-defined table game rules, said play parameter and said table game play data so as to calculate a game result for the at least one player; and communicating the game result to the mobile digital device of the at least one player.

In one embodiment the table defines a plurality of player positions, each of the player positions being respectively associated with a configurator disposed at or adjacent to the player position, the configurator being operable to configure the at least one player's mobile digital device to communicate the associated player position to the gaming server.

Preferably the configurator is, or makes use of, any one or more of: a QR code; a short-range wireless communications link; a Near-Field Communication device embedded in or adjacent to the table, a Radio-frequency identification transponder.

Preferably the method further includes allowing the at least one player to make an input into their mobile digital device whilst the table game is being played, the input defining play steps for the table game, and communicating the play steps to the gaming server.

In one embodiment the table game is a card game and the game surveillance equipment is a card shoe being associated with a sensor configured to identify each card drawn from the card shoe and communicate said identified card to the gaming server. Preferably, upon receipt of a communication identifying a card, the gaming server is configured to determine to which player the card was allocated and to cause a depiction of the identified card to be depicted on a screen of the mobile digital device of the player to which the card was allocated.

In another embodiment the table game is roulette and wherein the game surveillance equipment is a ball position sensor.

Preferably the gaming server is configured so as to cause the player's mobile digital device to display a depiction, or a stylised depiction, of the table.

An embodiment of the method further includes: allowing at least one observer who is not participating in the table game to observe the table game, the at least one observer having a mobile digital device; disposing an observer configurator at or adjacent to the table, the observer configurator being operable to configure the mobile digital device of the at least one observer to form a communications connection with the gaming server; allowing the at least one observer to make an input into their mobile digital device, the input defining a bet on either a current table game or an upcoming table game and communicating the bet to the gaming server; using the gaming server to process said bet and said table game play data so as to calculate a bet outcome for the at least one observer; and communicating the bet outcome to the mobile digital device of the at least one observer.

According to another aspect of the invention there is provided a table game system for use by at least one player having a mobile digital device, the table game system including: a gaming server; a table having a configurator disposed at or adjacent to the table, the configurator being operable to configure the least one player's mobile digital device to form a communications connection with the gaming server; and game surveillance equipment configured so as to generate table game play data and communicate said table game play data to the gaming server.

Preferably the table defines a plurality of player positions, each of the player positions being respectively associated with a configurator disposed at or adjacent to the player position, the configurator being operable to configure the at least one player's mobile digital device to communicate the associated player position to the gaming server.

In one embodiment a screen is positioned for viewing by an Attendant, the screen being driveable by the gaming server so as to display gaming information to the Attendant. This embodiment preferably includes input means operable by the Attendant to: de-register a player; and/or authorise a transfer to winnings to a player.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic depiction of an embodiment of a table game system according to the invention;

FIG. 2 is a flow chart showing an embodiment of a method of providing a table game according to the invention; and

FIGS. 3 to 5 are schematics of displays depicted on a mobile digital device of a player during play of a table game according to the embodiment of the method.

### DETAILED DESCRIPTION OF PREFERRED EMBODIMENTS OF THE INVENTION

Referring to the drawings, the first embodiment of the table game system 1 has a gaming server 2 in the form of computing hardware having a CPU, digital memory including database look up tables, and communications equipment capable of establishing communications with gaming equipment within the casino via, for example, a wireless local area network and/or via the Internet. In some embodiments the gaming server 2 is disposed within a server room of the casino. In other embodiments the gaming server 2 is disposed remotely and communicates with the gaming equipment within the casino using a cloud-based computing architecture.

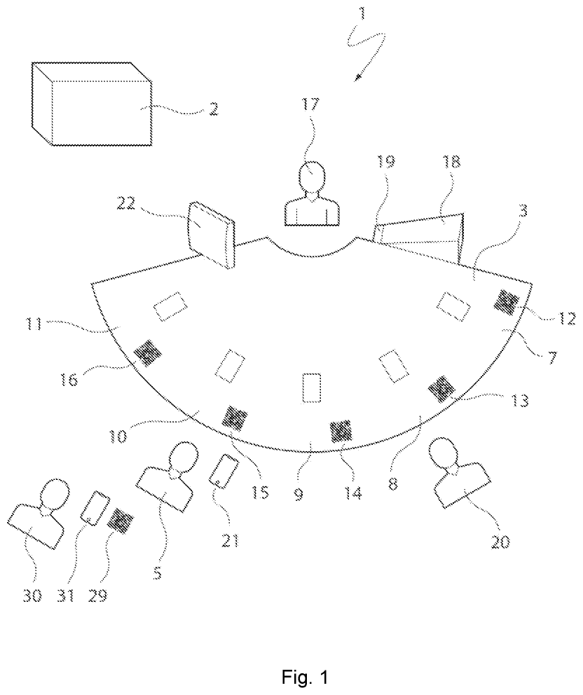

As is well known to those skilled in the art, a typical casino houses a number of tables, each of which is set up for play of a particular table game. Embodiments of the invention are configurable to work with various table games, including Baccarat, Blackjack, Pontoon, Roulette, Poker, Sic Bo, Pai Gow, Mississippi Stud, Caribbean Stud and Craps and others. The table 3 illustrated in FIG. 1 is configured for the playing of Blackjack and an example will be described with reference to this game. Once the general concepts associated with the invention are grasped, it will be readily possible for a person skilled in the art to apply the teachings of this patent specification to other table games.

The Blackjack table defines a plurality of player positions 7, 8, 9, 10, 11. Each of these player positions 7, 8, 9, 10, 11 is respectively associated with a configurator 12, 13, 14, 15, 16 disposed at or adjacent to the player position. In the preferred embodiment each configurator 12, 13, 14, 15, 16 is a QR code that is displayed on the table in easy reach of each position 7, 8, 9, 10, 11. However, in other embodiments the configurators 12, 13, 14, 15, 16 may be, or make use of: Near-Field Communication devices or radio-frequency identification transponders embedded in or adjacent to the table.

As illustrated in FIG. 1 for the sake of an example, positions 8 and 10 are taken by players 5 and 20. The other positions are left vacant for the sake of this example. Player 5 is electing to play via his or her mobile digital device 21, whereas Player 20 is electing to play in the traditional hands-on manner. In many circumstances, Player 5's mobile digital device 21 is likely to be a mobile smartphone. However, depending upon player preference and availability, it may also take other forms, such as a tablet, a laptop computer, a smart watch, an e-reader, a handheld gaming console and the like. From a hygiene viewpoint it is preferable that the mobile digital device 21 is the player's personal mobile digital device, because this implies that it is only the player who is likely to have handled it recently. Alternatively, it may be a mobile digital device 21 given to player by casino staff. In this case, the mobile digital device is preferably disinfected prior to being given to the player.

The Attendant, who in a card game context will be referred to as a Dealer 17, is positioned at the opposite side of the table 3 from the players. Positioned within reach of the Dealer is a card shoe 18, which is loaded with a number of packs of randomly shuffled cards. The card shoe 18 is arranged such that the Dealer 17 can extract a single card from the card shoe 18 and, as it is extracted, it is scanned by game surveillance equipment in the form of a sensor such as an optical scanner unit 19, which generates table game play data in the form of an image file that is representative of the card. This image file is automatically communicated from the scanner unit 19 to the gaming server 2. An optical recognition routine is executed at the gaming server 2, which identifies the card that was extracted, for example, as a Queen of Hearts. Both the image file and the data indicative of the card as generated by the optical recognition routine are stored in the memory of the gaming server 2.

A screen 22 is positioned for viewing by the Dealer. To assist the Dealer in running the table game, the screen 22 is driven by the gaming server 2 so as to display gaming information to the Attendant. The screen 22 is touch sensitive and therefore can receive inputs from the Attendant to take gaming administrative steps such as de-registering a player when they choose to leave the game if the player neglects to de-register themselves by pressing the ‘Leave’ button 33. These inputs are communicated to the gaming server 2. In some embodiments the Dealer is also responsible for authorising a transfer of winnings to a player; however, in other embodiments the gaming server is configured to automatically initiate such transfers.

The example gaming situation illustrated in FIG. 1 commences with Player 5 sitting at position 10 and Player 20 sitting at position 8. They are both at table 3, which is a Blackjack table that is identified for casino purposes as ‘BJT1’. The preferred embodiment allows the players to choose to play in either the traditional hands-on manner, which is the option taken by Player 20, or in the virtual manner that will be described in more detail below. Importantly, the two game play modes can run concurrently on a single table 3, with the traditional game play steps being taken by Player 20 being essentially unaltered by the concurrent virtual play of Player 5. Hence, this detailed description will focus mainly upon the steps and processes associated with the virtual game play of Player 5.

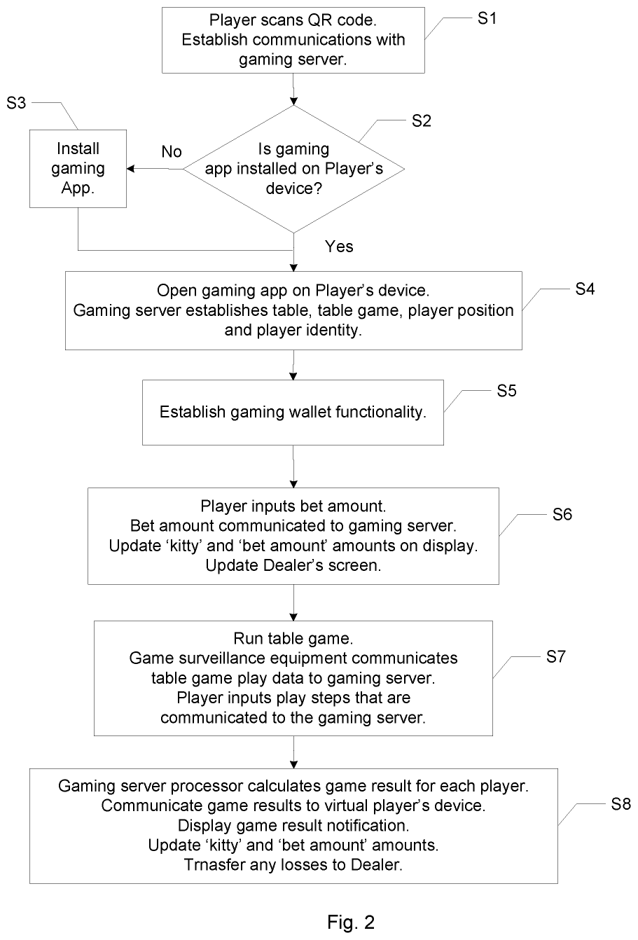

Turning to the flowchart illustrated in FIG. 2, Player 5 commences at Step 51 by scanning configurator QR code 15 (which is the configurator associated with this player's position 10) with the camera of his or her mobile digital device, which in this case is a mobile phone 21. This generates image data that is decoded by the processor of the mobile phone 21 to yield a pointer pointing the mobile phone 21 to a web site hosted by the gaming server 2. Player 5 then allows his mobile phone 21 to open this web site pointed to by configurator 15.

At Step S2 the gaming server 2 interacts with the player's mobile digital device 21 to check if the necessary gaming application has already been installed onto the player's mobile digital device 21. If not, at Step S3 the web site prompts the player to download the gaming application onto the player's mobile digital device. Once it has been downloaded, or if it is already installed, then it is opened at Step S4.

The gaming application is executable by the player's mobile digital device 21 to maintain a communications connection between the player's mobile digital device 21 and the gaming server 2. At the establishment of the communications connection, the gaming server 2 is configured to instruct the mobile digital device 21 to perform various real-time checks intended to validate the player's identity and ensure compliance with regulatory and/or premises-based requirements. One of these checks is verification of the player's identity, which in some embodiments is performed using identification technologies that are native to the mobile digital device 21, such as facial recognition, fingerprint scanning. etc. This generates identification data that in one embodiment is processed by the gaming application and in another embodiment the identification data is processed by a third-party application. In yet another embodiment, the gaming server 2 makes use of external identification technologies, such as facial recognition of footage taken by in-house security cameras, for example. In this embodiment, once identification validation has been completed, the gaming server 2 communicates the validation status to the gaming application. Once a positive player identification has been achieved, the next checks typically involve verifying that the player has met any additional requirements, such as age requirements, vaccination status, self-exclusion status, bet limitations and the like. In one embodiment these additional requirements are stored in the memory of the player's mobile digital device 21 and are accessible by the gaming application. In another embodiment, these additional requirements are stored in a database that is accessible to the gaming server 2. Hence the gaming application and/or the gaming server 2 may be configured to ensure compliance with these additional requirements. Another type of check that may be required for regulatory purposes, or as an example of a premises-based requirement, is ensuring that the mobile digital device 21 is within a pre-defined geographical range whilst it is being used for gaming purposes. For example, it may be a regulatory requirement, or a premises requirement, that the mobile digital device 21 be located within a pre-defined gaming region of the premises whilst it is being used for gaming purposes. This is achieved in some embodiments by using the native location functionality of the mobile digital device 21, such as the use of the Global Positioning System for example, to implement methods such as geofencing to define a virtual perimeter within which the mobile digital device 21 must be located in order to provide the gaming functionality.

In an alternative embodiment, some or all of these checks are performed automatically by the player's mobile digital device 21 whenever the gaming application is opened without any requirement for the checks to be initiated by the gaming server 2. In another embodiment, some or all of these checks are performed repeatedly during the player's gaming activities, such as at regular timed intervals, whenever a bet is placed or the like.

Next, the gaming server 2 identifies the particular configurator QR code 15 that the player scanned. The gaming server 2 makes use of a look up table to determine the specific table, table game and player position associated with that particular configurator QR code 15. The gaming server 2 also identifies the mobile digital device 21 of Player 5 and uses another look up table to determine the identity of Player 5. Hence, in the example, the gaming server 2 now knows the identity of Player 5 and that this player is sitting at position 10 on Blackjack table BJT1. This information is stored in the memory of the gaming server 2. The Dealer also makes an input onto the Dealer's touch-sensitive screen 22, which notifies the gaming server that a traditional Player 20 is also participating in the game. This is also stored in the gaming server's memory.

As will be described in more detail below, the communications connection also allows the Player 5 to make inputs on the mobile digital device 21, which are communicated to the gaming server 2. It also allows the gaming server 2 to control the information displayed on the mobile digital device to Player 5.

Another embodiment dispenses with the need for a gaming application to be installed on the player's mobile digital device 21. In this embodiment the Player 5 continues to interact with the gaming server 2 via the web site through which the communications connection between the player's mobile digital device and the gaming server was initially established.

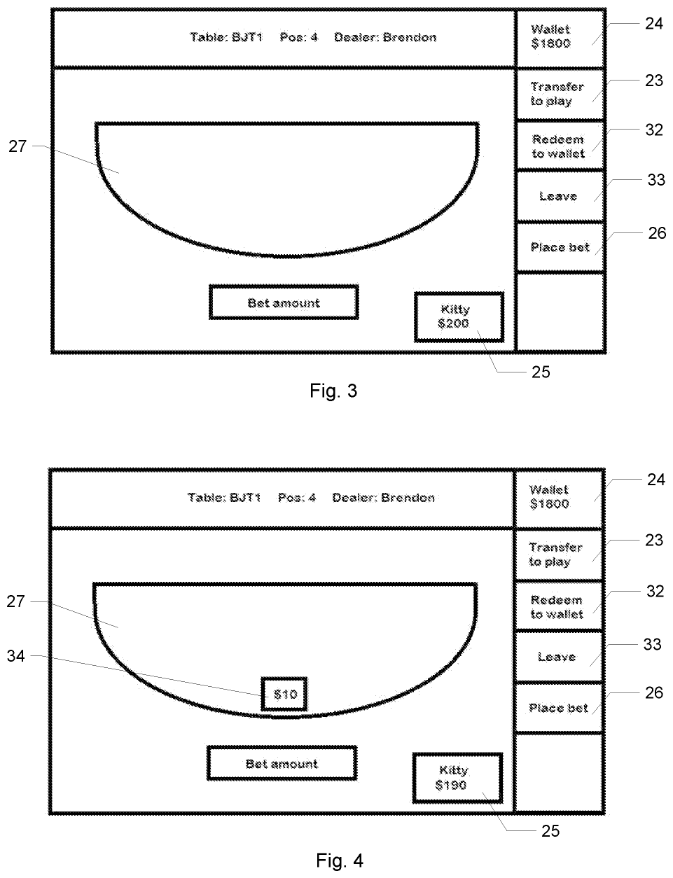

At Step S5 the gaming application configures the player's mobile digital device 21 to provide gaming wallet functionality. As an example, we shall assume that Player 5 initially has no funds in the gaming wallet. The gaming application prompts Player 5 to provide a payment means, such as credit or debit card details, a transfer from a cryptocurrency account, or the like. In the example we shall assume that Player 5 transfers $2000 into the gaming wallet 24. The display of the player's mobile digital device 21 includes a ‘Transfer’ button 23, which allows the player to transfer funds from the gaming wallet 24 into the kitty 25, which is a store of value from which bets may be placed. Pressing the ‘Transfer’ button 23 in the gaming application causes the player's mobile digital device 21 to prompt the player to input an amount, which in the example we shall assume is $200. At this point the gaming server 2 causes a display such as that illustrated in FIG. 3 to be displayed on the player's mobile digital device 21. The Player 5 may also transfer funds from the kitty 25 back to the gaming wallet 24 by pressing the ‘Redeem to Wallet’ button 32.

As stated above, the gaming server 2 knows the specific Blackjack table, which in this example is called BJT1, at which Player 5 is sitting. Hence, to increase the realism of the virtual experience, the gaming server 2 is configured to cause the screen of Player 5's mobile digital device 21 to display a depiction, or a stylised depiction, of the actual table 3 at which Player 5 is sitting. To achieve this, the gaming server 2 has a database that includes all of the available tables in the casino and includes graphics depictions, or stylised depictions, of each of those tables. Hence, once the gaming server 2 has determined which table 3 the Player 5 is at, it accesses this database to find the relevant depiction to instruct the player's mobile digital device 21 to display. Given that the gaming server 2 also knows the position of Player 5 at the table 3, additional realism may be achieved by instructing the player's mobile digital device 21 to display a stylised depiction of a player at that position on the displayed image of the table.

In addition to increased realism, another benefit associated with displaying a fairly accurate representation of the table 3 on the player's mobile digital device 21 is that it allows the player's inputs to match the gaming options that are available at the relevant table 3. For example, it will be appreciated by those skilled in the art that some gaming tables feature bonusing options, such as one or more spaces designed for the placement of side bets. Hence, the depiction of the table 3 on the player's mobile digital device will also include a depiction of the side bet placement spaces. If the Player 5 wishes to initiate the placement of a side bet, the Player 5 may touch a depiction of a side bet space. This is detected by the gaming application due to the touch sensitive nature of the screen of the mobile digital device 21. In response to this input, the gaming application prompts the Player 5 to input a bet amount to define the parameters of the side bet. Once placed, this side bet is communicated to the gaming server 2 for storage and later processing.

At Step S6 the Player 5 makes an input into their mobile digital device, the input defining a play parameter for an upcoming table game. More specifically, prior to the commencement of a Blackjack game, the Player 5 presses the ‘Place Bet’ button 26, which causes the player's mobile digital device to prompt Player 5 to input an amount. In the example this is $10. This bet amount is communicated to the gaming server 2 and stored in its memory. The gaming server 2 then causes the display of the player's mobile digital device to show a display such as that illustrated in FIG. 4, wherein the kitty has reduced to $190 and a bet amount 34 of $10 is depicted on the virtual table 27. The gaming server also causes the Dealer's display screen 22 to depict the $10 bet as being applicable to Player 5.

As mentioned above, the gaming server 2 monitors and its memory stores the bet amounts made by Player 5. At the discretion of the casino, this data may be utilised to configure the gaming server 2 to offer rewards to that player, for example free meals or the like, based upon the player's table gaming activities. As mentioned earlier, the gaming server 2 has knowledge of the identity of Player 5, which allows it to access the player's reward account if the gaming server 2 has been configured to administer a player rewards program.

Once all active players have placed their bets (whether via inputs into their mobile digital devices or by placing chips on the table in the traditional fashion), at Step S7 the Dealer commences running the table game in accordance with its pre-defined table game rules. For Blackjack this entails dealing a first card to the players in a pre-defined dealing order, which is clockwise from the Dealer's perspective. Hence, for the arrangement shown in FIG. 1, the Dealer pulls a card from the card shoe 18 and deals this first card to Player 20 as per the pre-defined dealing order. As discussed above, drawing the card out of the card shoe 18 causes the card to be scanned by the game surveillance equipment (i.e., scanner 19), which generates table game play data (i.e., an image file of the card), which is communicated to the gaming server 2.

Upon receipt of this communication of the card image file, the gaming server 2 is configured to perform the optical recognition routine mentioned above and to determine to which player the card was allocated. This is made possible because the logic of the CPU of the gaming server 2 is aware of the number of players at the table 3, their positioning at the table and the pre-defined dealing order. The logic of the gaming server 2 can therefore determine that Player 20 is the player to whom the first card was dealt. The fact that Player 20 has been dealt this first card is stored in the memory of the gaming server 2. The logic of the gaming server 2 is also aware that a Player 20 is a traditional player. Hence, there is no need to update a display on a mobile digital device because Player 20 is not using one.

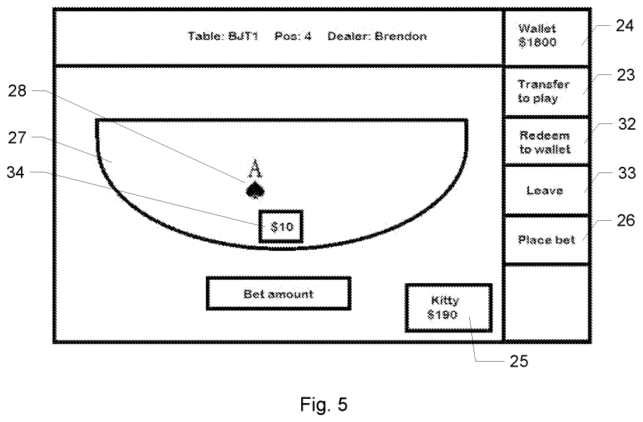

The Dealer 17 then draws a second card from the card shoe 18 and, in accordance with the pre-defined dealing order, this is dealt to Player 5. Once again, the drawing of the card from the card shoe 18 causes it to be scanned by the scanner 19 and the resultant image file is communicated to the gaming server 2. Using the same deductive process as outlined in the preceding paragraph, the logic of the gaming server 2 determines that the second card has been dealt to Player 5 and this fact is stored in the memory of the gaming server 2. The logic of the gaming server 2 is also aware that Player 5 is a virtual player because that player's mobile digital device 21 is registered in this game. For virtual players the gaming server 2 is configured to cause the screen of the player's mobile digital device to display information indicative of table game play data. Hence, the gaming server 2 causes a depiction of the identified card to be displayed on the screen of the mobile digital device 21 of the player to which the card was allocated. That is, the gaming server 2 updates the display on Player 5's mobile digital device 21 to depict the card 28 on the virtual table 27, as illustrated for example in FIG. 5.

The dealing continues in this manner until each player and the dealer has received two cards with the gaming server 2 being kept informed of the progress. Then, in accordance with the pre-defined rules of Blackjack, each player is given a chance to ‘stand’ or ‘hit’. In accordance with the pre-defined dealing order, this option is given firstly to traditional Player 20, and the Dealer provides an input onto the touch sensitive screen 22, which informs the gaming server 2 of Player 20's actions. Hence, if the Dealer informs the gaming server 2 that Player 20 has elected to hit, the next card drawn is allocated by the gaming server 2 to Player 20. If the Dealer informs the gaming server 2 that Player 20 has elected to stand, the next card drawn, if any, will be allocated by the gaming server 2 to Player 5. Once Player 5 is given the opportunity to ‘stand’ or ‘hit’, in one embodiment the Dealer provides an input that is communicated to the gaming server 2 in the same manner as just described for Player 20. However, in another embodiment, the virtual players are prompted to make an input into their mobile digital devices 21 whilst the table game is being played, the input defining play steps for the table game, and communicating the play steps to the gaming server. In other words, in the example Player 5 presses either a ‘stand’ or ‘hit’ button on their mobile digital device 21 and this is acted upon by the Dealer and communicated to the gaming server 2.

At the conclusion of the table game, at Step S8, the gaming server 2 has stored in its memory the various cards that were dealt to the various players and to the Dealer. This allows the logic of the CPU of the gaming server 2 to process the pre-defined Blackjack rules, the play parameters and the table game play data so as to calculate a game result for each of the players. For those players registered with the gaming server 2 as virtual players, which in the example illustrated in FIG. 1 is Player 5, the gaming server 2 communicates the game result to Player 5's mobile digital device 21. This takes the form of either a win notification or a lose notification. In the event of a win, the gaming server 2 is configured to calculate an amount won and to instruct the player's mobile digital device 21 to display the win amount on the screen of Player 5's mobile digital device and to increment Player 5's kitty by this amount. In the event of a loss, the gaming server is configured to transfer the amount bet by Player 5 to the Dealer's account. The gaming server 2 then drives the display of Player 5's mobile digital device 21 to depict a display similar to that shown in FIG. 3 (although with the various amounts updated as required) in preparation for further gaming activities.

In addition to its use by table gaming participants, the embodiment may be configured to provide non-participating observers of the table game with an option to place bets on the table gaming activities. Such an observer 30 is depicted in FIG. 1 and this observer has a mobile digital device 31. An observer configurator 29 is disposed at or adjacent to the table 3 and it is clearly labelled as such to avoid confusion with the configurators 12, 13, 14, 15, 16 that are for use by the players 5. The observer configurator 29 is operable to configure the observer's mobile digital device 31 to form a communications connection with the gaming server 2. In a similar manner to that described above for the players, the connection with the gaming server 2 ultimately results in the opening of a gaming application having a gaming wallet having a kitty on the observer 30's mobile digital device 31. This allows the observer 30 to make an input into their mobile digital device 31, which defines a bet on either a current table game or an upcoming table game. Such a bet may be upon a result of the game that the observer believes may be achieved by one of the players or by the Dealer. It may also be upon a particular gaming step taken during the table game, such as a bet upon the next card that the observer believes may be dealt to a particular player. This bet is communicated to the gaming server 2 and, at an appropriate juncture, the gaming server 2 processes the bet and the table game play data so as to calculate a bet outcome for the observer 30. The gaming server 2 then communicates the bet outcome to the observer 30's mobile digital device 31 and causes the display to notify the observer of the bet outcome. Additionally, the gaming server 2 calculates a win or loss amount based upon the bet outcome and instructs the gaming application on the observer's mobile digital device to update the observer 30's kitty credit values as appropriate.

In the example given above, the order of the players as positioned around the Blackjack table 3 has a substantial bearing upon the play of the game, because this determines the specific cards that are dealt to each player. That is, if the players were positioned differently around the table 3, but the pre-defined dealing order were to remain constant, then the players would receive different cards. Hence, for such position-dependent games, it is necessary to use configurators that can provide high positional accuracy, such as QR codes, NFC and RFID technologies. In contrast, however, in some other games, such as Roulette for example, the positioning or order of the players 5 around the Roulette table has little to no bearing on the play of the game. For such games, there is no need to provide a separate configurator for each player position in the manner described above. Rather, it suffices to provide a small number of configurators on or adjacent to the Roulette table, any of which can be used by any of the players. Once one of these configurators is used to establish a communications connection between the player's mobile digital device and the gaming server 2, there is no need for the gaming server 2 to distinguish between such configurators. Rather, it is merely necessary for the gaming server 2 to register each of the players to the relevant Roulette table. Given that minimal positional accuracy is required, such embodiments may make use of not only the types of configurator technologies mentioned earlier, but also other less positionally accurate options including short-range wireless technology such as Bluetooth®, for example.

For the embodiment in which the table game is configured for Roulette, the game surveillance equipment is a ball position sensor, which may take the form of ball sensors built into the positions on the Roulette wheel where the ball may come to rest. In another embodiment the ball position sensor makes use of optical sensors. Additionally, for a game such as Roulette, the play parameters that are input by the player prior to the commencement of a game can not only include bet amounts, but also other betting information such as the numbers or other Roulette groupings being bet upon. For a typical Roulette game, no further player input to define any play steps is required once the game commences.

Some embodiments may provide a number of advantages. From a hygiene perspective, embodiments may provide an option for players to participate in table gaming without the need to touch chips, cards or other traditional gaming elements. They also provide a novel gaming experience that is likely to be considered attractive to those players who enjoy interacting with their mobile digital device 21. They also allow traditional table gaming to be offered concurrently with virtual table gaming at a single table. From the casino's perspective, the embodiments may also provide a number of advantages. They may simplify the tracking of a player's table game-based gaming activities, which may assist with the implementation of a player rewards system. They may also offer improved security by mitigating the risk that a Dealer may collude with a Player. They may also offer the casino with improved tracking of player's gaming activities, which is likely to assist in combating nefarious activities such as money laundering.

While a number of embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A method of providing a table game at a table to at least one player having a mobile digital device, the method including:
providing a gaming server;
a configurator being disposed at or adjacent to the table, the configurator being operable to configure the least one player's mobile digital device to form a communications connection with the gaming server;
allowing the at least one player to make an input into their mobile digital device, the input defining a play parameter for an upcoming table game;
communicating the play parameter to the gaming server;
running the table game in accordance with pre-defined table game rules;
operating game surveillance equipment so as to generate table game play data;
communicating said table game play data to the gaming server;
at a conclusion of a table game, using the gaming server to process said pre-defined table game rules, said play parameter and said table game play data so as to calculate a game result for the at least one player; and
communicating the game result to the mobile digital device of the at least one player.

2. A method according to claim 1 wherein the table defines a plurality of player positions, each of the player positions being respectively associated with a configurator disposed at or adjacent to the player position, the configurator being operable to configure the at least one player's mobile digital device to communicate the associated player position to the gaming server.

3. A method according to claim 1 wherein the configurator is, or makes use of, any one or more of:
a QR code; a short-range wireless communications link; a Near-Field Communication device embedded in or adjacent to the table, a Radio-frequency identification transponder.

4. A method according to claim 1 wherein the configurator points the mobile digital device to either:
a web site prompting the player to either download an application onto the player's mobile digital device, the application being executable to provide the communications connection between the player's mobile digital device and the gaming server or, if the application is already installed on the player's mobile digital device, the web site prompts the play to open the application; or
a web site through which the communications connection between the player's mobile digital device and the gaming server is established and maintained.

5. A method according to claim 1 wherein the play parameter is a bet amount.

6. A method according to claim 1 wherein the gaming server is configured to cause the player's mobile digital device to display information indicative of said table game play data on a screen of the mobile digital device.

7. A method according to claim 1 further including allowing the at least one player to make an input into their mobile digital device whilst the table game is being played, the input defining play steps for the table game, and communicating the play steps to the gaming server.

8. A method according to claim 1 wherein the table game is run by an attendant and wherein a screen is positioned for viewing by the Attendant, the screen being driven by the gaming server so as to display gaming information to the Attendant including:
a list of the players currently registered to play on the table; and/or
bets placed by the players in a current table game, and further including input means allowing the attendant to:
de-register a player; and/or
authorise a transfer to winnings to a player.

9. A method according to claim 1 wherein the table game is a card game and wherein the game surveillance equipment is a card shoe being associated with a sensor configured to identify each card drawn from the card shoe and communicate said identified card to the gaming server and wherein, upon receipt of a communication identifying a card, the gaming server is configured to determine to which player the card was allocated and to cause a depiction of the identified card to be depicted on a screen of the mobile digital device of the player to which the card was allocated and wherein the determination by the gaming server of the player to which the card was allocated is dependent upon a pre-defined dealing order.

10. A method according to claim 1 wherein the table game is roulette and wherein the game surveillance equipment is a ball position sensor.

11. A method according to claim 1 wherein the game result includes a win amount calculated by the gaming server and wherein the gaming server instructs the player's mobile digital device to increment the player's gaming account by the win amount and wherein the gaming server is configured so as to cause the player's mobile digital device to display the win amount on the player's mobile digital device.

12. A method according to claim 1 wherein the gaming server is configured so as to cause the player's mobile digital device to display a depiction, or a stylised depiction, of the table.

13. A method according to claim 1 wherein the gaming server is configured to provide player rewards based upon the player's table game activities as monitored by gaming server.

14. A method according to claim 1 further including:
allowing at least one observer who is not participating in the table game to observe the table game, the at least one observer having a mobile digital device;
disposing an observer configurator at or adjacent to the table, the observer configurator being operable to configure the mobile digital device of the at least one observer to form a communications connection with the gaming server;
allowing the at least one observer to make an input into their mobile digital device, the input defining a bet on either a current table game or an upcoming table game and communicating the bet to the gaming server;
using the gaming server to process said bet and said table game play data so as to calculate a bet outcome for the at least one observer; and
communicating the bet outcome to the mobile digital device of the at least one observer.

15. A table game system for use by at least one player having a mobile digital device, the table game system including:
a gaming server;
a table having a configurator disposed at or adjacent to the table, the configurator being operable to configure the least one player's mobile digital device to form a communications connection with the gaming server; and
game surveillance equipment configured so as to generate table game play data and communicate said table game play data to the gaming server.

16. A table game system according to claim 15 wherein the table defines a plurality of player positions, each of the player positions being respectively associated with a configurator disposed at or adjacent to the player position, the configurator being operable to configure the at least one player's mobile digital device to communicate the associated player position to the gaming server.

17. A table game system according to claim 15 wherein a screen is positioned for viewing by an Attendant, the screen being driveable by the gaming server so as to display gaming information to the Attendant.

18. A table game system according to claim 17 including input means operable by the Attendant to:
de-register a player; and/or
authorise a transfer to winnings to a player.

19. A table game system according to claim 15 wherein the table is configured for the playing of a card game and wherein the game surveillance equipment is a card shoe being associated with a sensor configured to identify each card drawn from the card shoe and communicate said identified card to the gaming server.

20. A table game system according to claim 15 wherein the table is configured for the playing of roulette and wherein the game surveillance equipment is a ball position sensor.
